(19) United States
(12) Patent Application Publication
(10) Pub. No.: US 2015/0240717 A1
(43) Pub. Date: Aug. 27, 2015

(54) Increasing Combustibility of Low BTU Natural Gas

(71) Applicants: Loren K. STARCHER, Sugar Land, TX (US); Franklin F. MITTRICKER, Jamul, CA (US); P. Scott NOTHROP, Spring, TX (US); Charles J. MART, Baton Rouge, LA (US)

(72) Inventors: Loren K. Starcher, Sugar Land, TX (US); Franklin F. Mittricker, Houston, TX (US); P. Scott Northrop, Spring, TX (US); Charles J. Mart, Baton Rouge, LA (US)

(21) Appl. No.: 14/427,246

(22) PCT Filed: Sep. 30, 2013
(86) PCT No.: PCT/US2013/062702

§ 371 Date: Mar. 10, 2015

Related U.S. Application Data
(60) Provisional application No. 61/714,606, filed on Oct. 16, 2012.

(51) Int. Cl. F02C 3/22; F02C 3/30; F02C 3/24; C25B 1/02; F02C 3/20

(52) U.S. Cl. CPC F02C 3/22; C25B 1/02; F02C 3/20; F02C 3/24; F02C 3/30

(57) ABSTRACT

A system and methods for increasing a combustibility of a low BTU natural gas are provided herein. The method includes increasing the adiabatic flame temperature of the low BTU natural gas using heavy hydrocarbons, wherein the heavy hydrocarbons include compounds with a carbon number of at least two. The method also includes burning the low BTU natural gas in a gas turbine.

### CROSS-REFERENCE TO RELATED APPLICATION

This application claims the benefit of U.S. Provisional Patent Application 61/714,606 filed Oct. 16, 2012, entitled INCREASING COMBUSTIBILITY OF LOW BTU NATURAL GAS, the entirety of which is incorporated by reference herein.

### FIELD OF THE INVENTION

The present techniques are directed to a system and methods for increasing the combustibility of low BTU natural gas. More specifically, the present techniques are directed to a system and methods for treating low BTU natural gas for combustion in a gas turbine.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

It may be desirable to utilize low quality natural gas resources, e.g., natural gas resources with as low as 15% methane (˜150 BTU/SCF), as fuel within a gas turbine. However, according to current techniques, in order to make these gases suitable for gas turbine fuel, the addition of hydrogen or the removal of some of the inert gases is performed. In addition, current techniques include relatively expensive process steps that may not be necessary for gases that are closer to the required gas turbine fuel specifications.

Further, in many cases, hydrogen sulfide (H₂S) and carbon dioxide (CO₂) are present in relatively large amounts in natural gas. It may be desirable to selectively remove the H₂S ahead of the CO₂ removal process, e.g., using a cryogenic distillation process, to generate a clean liquid CO₂ stream from the natural gas product. The CO₂ stream may be used for enhanced oil recovery (EOR) processes. In addition, the purified natural gas may be used to generate power with very low levels of emissions. Further, relatively low concentrations of H₂S (up to about 1%) can be burned in the gas turbine without effecting the maintenance cycle of the machine. Burning the H₂S may increase flame stability. In this case, scrubbing Sox from the flue gas may be more economical than H₂S removal from the fuel.

A number of H₂S-selective processes are available for the removal of H₂S from natural gas, including selective amine processes, redox processes, adsorbent processes, and physical solvent processes. In general, non-aqueous processes are more economical, since aqueous processes involve an additional dehydration step.

In the case of the cryogenic distillation process, any heavy hydrocarbons, such as C₂ and higher, in the raw natural gas stream substantially end up mostly in the liquid CO₂ bottoms stream. It is difficult to separate these hydrocarbons from the CO₂, although they may contain significant caloric value. However, this high-CO₂ mixture has too low of a BTU value to be viable as a combustion fuel without further treatment.

### SUMMARY

An exemplary embodiment provides a method for increasing the combustibility of a low BTU natural gas. The method includes increasing the adiabatic flame temperature of the low BTU natural gas using heavy hydrocarbons, wherein the heavy hydrocarbons include compounds with a carbon number of at least two. The method also includes burning the low BTU natural gas in a gas turbine.

Another exemplary embodiment provides a system for using a low BTU natural gas as fuel within a gas turbine. The system includes a gas treatment system configured to increase a combustibility of the low BTU natural gas through the use of heavy hydrocarbons having a carbon number of at least two. The system also includes a gas turbine configured to generate power using the low BTU natural gas, wherein a combustibility of the low BTU natural gas is increased.

Another exemplary embodiment provides a method for treating a low BTU natural gas for combustion in a gas turbine. The method includes removing hydrogen sulfide and carbon dioxide from the low BTU natural gas and producing hydrogen from the hydrogen sulfide. The method also includes combining the low BTU natural gas with the hydrogen and heavy hydrocarbons to generate a mixture with a combustibility that is higher than an initial combustibility of the low BTU natural gas and burning the mixture in the gas turbine.

### BRIEF DESCRIPTION OF THE DRAWINGS

The advantages of the present techniques are better understood by referring to the following detailed description and the attached drawings, in which:

FIG. 1 is a block diagram of a system for enhancing the combustibility of a low BTU natural gas;

FIG. 2 is a simplified process flow diagram of a system for treating a raw low BTU natural gas for use in a gas turbine via the removal of hydrogen sulfide (H₂S) and carbon dioxide (CO₂);

FIG. 3 is a simplified process flow diagram of a system for removing H₂S and CO₂ from a low BTU natural gas via a selective amine process and a controlled freeze zone (CFZ) process;

FIG. 4 is a simplified process flow diagram of a system for removing H₂S and CO₂ from a raw low BTU natural gas through the use of a molecular sieve bed and a CFZ tower;

FIG. 5 is a simplified process flow diagram of a system for removing H₂S from a sour low BTU natural gas;

FIG. 6 is a simplified process flow diagram of a system for generating CO₂ and producing power using low value fuels;

FIG. 7 is a process flow diagram of a method for increasing the combustibility of a low BTU natural gas; and

FIG. 8 is a process flow diagram of a method for treating a low BTU natural gas for combustion in a gas turbine.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Acid gases” are contaminants that are often encountered in natural gas streams. Typically, these gases include carbon dioxide (CO₂) and hydrogen sulfide (H₂S), although any number of other contaminants may also form acids. Acid gases are commonly removed by contacting the gas stream with an absorbent, such as an amine, which may react with the acid gas. When the absorbent becomes acid-gas “rich,” a desorption step can be used to separate the acid gases from the absorbent. The “lean” absorbent is then typically recycled for further absorption. As used herein, a “liquid acid gas stream” is a stream of acid gases that are condensed into the liquid phase, for example, including CO₂ dissolved in H₂S and vice-versa.

A “combined cycle power plant” is a facility that uses both steam and a gas turbine to generate power. A combined cycle power plant includes a gas turbine, a steam turbine, a generator, and a heat recovery steam generator (HRSG). The gas turbine may operate in an open or closed Brayton cycle, and the steam turbine operates in a Rankine cycle. Typically, combined cycle power plants utilize heat from the gas turbine exhaust to boil water in the HRSG to generate steam. The steam generated is utilized to power the steam turbine. After powering the steam turbine, the steam may be condensed, and the resulting water may be returned to the HRSG. The gas turbine and the steam turbine can be utilized to separately power independent generators, or in the alternative, the steam turbine can be combined with the gas turbine to jointly drive a single generator via a common drive shaft. These combined cycle gas/steam power plants generally have higher energy conversion efficiency than gas or steam only plants. A combined cycle power plant's efficiencies can be as high as 50% to 60%. The higher combined cycle efficiencies result from synergistic utilization of a combination of the gas turbine with the steam turbine.

A “controlled freeze zone (CFZ™) process” is a cryogenic distillation technology available from Exxon Mobil. The CFZ process is used for the separation of acid gas components by cryogenic distillation through the controlled freezing and melting of carbon dioxide in a single column, without the use of freeze-suppression additives. The CFZ process uses a cryogenic distillation column with a special internal section, e.g., a CFZ section, to handle the solidification and melting of CO₂. This CFZ section does not contain packing or trays like conventional distillation columns but, instead, contains one or more spray nozzles and a melting tray. Solid carbon dioxide forms in the vapor space in the distillation column and falls into the liquid on the melting tray. Substantially all of the solids that form are confined to the CFZ section. The portions of the distillation tower above and below the CFZ section of the tower are similar to conventional cryogenic demethanizer columns.

A “compressor” is a device for compressing a working gas, including gas-vapor mixtures or exhaust gases, and includes pumps, compressor turbines, reciprocating compressors, piston compressors, rotary vane or screw compressors, and devices and combinations capable of compressing a working gas. In some embodiments, a particular type of compressor, such as a compressor turbine, may be preferred. A piston compressor may be used herein to include a screw compressor, rotary vane compressor, and the like.

“Enhanced oil recovery” or “EOR” is a generic term for techniques for increasing the amount of oil that can be extracted from an oil field. Using EOR, approximately 30-60% of a reservoir's original oil can be extracted, compared with 20-40% using primary and secondary recovery. Typical fluids used for EOR include gases, liquids, steam, or other chemicals, with gas injection being the most commonly used EOR technique. In a gas type EOR, gas such as carbon dioxide (CO₂), natural gas, or nitrogen is injected into the reservoir, whereupon it expands and thereby pushes additional crude oil to a production wellbore.

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state. As used herein, “fluid” is a generic term that can encompass either liquids or gases.

A “hydrocarbon” is an organic compound that primarily includes the elements hydrogen and carbon, although nitrogen, sulfur, oxygen, metals, or any number of other elements may also be present in small amounts. As used herein, hydrocarbons generally refer to organic materials that are harvested from hydrocarbon containing sub-surface rock layers, termed reservoirs, such as natural gas.

“Liquefied natural gas” or “LNG” is a cryogenic liquid form of natural gas generally known to include a high percentage of methane, but also other elements and/or compounds including, but not limited to, ethane, propane, butane, carbon dioxide, nitrogen, helium, hydrogen sulfide, or combinations thereof. The natural gas may have been processed to remove one or more components (for instance, helium) or impurities (for instance, water and/or heavy hydrocarbons) and then condensed into liquid at almost atmospheric pressure by cooling.

A “low BTU natural gas” is a gas that includes a substantial proportion of CO₂ as harvested from a reservoir. For example, a low BTU natural gas may include 10 mol % or higher CO₂ in addition to hydrocarbons and other components. In some cases, the low BTU natural gas may include mostly CO₂. In addition, a low BTU natural gas is characterized by a low calorific value range, e.g., between around 90 and 700 British thermal units per standard cubic feet (BTU/scf), wherein the calorific value defines the amount of heat released when the low BTU natural gas is burned.

“Low methane natural gas reserves” or “low BTU natural gas reserves” are reserves that have less than 40% methane content by volume. This methane content is normally found to be under the acceptable level for stable combustion in gas turbines. It is uneconomic to remove all the impurities in these low methane natural gas reserves to convert them into pipeline quality natural gas. Therefore, reserves with these low methane contents are currently not being developed.

The term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C₁) as a significant component. Raw natural gas will also typically contain higher carbon number compounds, such as ethane (C₂), propane, and the like, as well as acid gases (such as carbon dioxide, hydrogen sulfide, carbonyl sulfide, carbon disulfide, and mercaptans), and minor amounts of contaminants such as water, nitrogen, iron sulfide, wax, and crude oil.

“Pressure” is the force exerted per unit area by the gas on the walls of the volume. Pressure can be shown as pounds per square inch (psi). “Atmospheric pressure” refers to the local pressure of the air. “Absolute pressure” (psia) refers to the sum of the atmospheric pressure (14.7 psia at standard conditions) plus the gauge pressure (psig). “Gauge pressure” (psig) refers to the pressure measured by a gauge, which indicates only the pressure exceeding the local atmospheric pressure, i.e., a gauge pressure of 0 psig corresponds to an absolute pressure of 14.7 psia. The term “vapor pressure” has the usual thermodynamic meaning. For a pure component in an enclosed system at a given pressure, the component vapor pressure is essentially equal to the total pressure in the system.

“Sour gas” generally refers to natural gas containing sour species such as hydrogen sulfide (H₂S) and carbon dioxide (CO₂). When the H₂S and CO₂ have been removed from the natural gas feed stream (for example, decreased to 10 ppm or less, or 5 ppm or less), the gas is classified as “sweet.”

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

### OVERVIEW

Techniques described herein provide for the improvement of the combustion stability of low methane, or low BTU, natural gas. By using one or a series of the techniques described herein, such low BTU natural gas can be made into suitable fuels for gas turbines. In some cases, only one of the techniques described herein may be used to increase the combustibility of a low BTU natural gas, while, in other cases, a combination of the techniques may be used to increase the combustibility of the low BTU natural gas.

There are many techniques for measuring the relative combustion stability of gas mixtures, such as, for example, measuring the adiabatic flame temperature. The adiabatic flame temperature can be accurately calculated according to a variety of methods. For example, according to embodiments described herein, the adiabatic flame temperature may be estimated by dividing the low heating value of the fuel mixture by the product of the mass of the combustion products and the average specific heat of the combustion products (from ambient to final temperature) at stoichiometric conditions. In addition, since a mixture that includes about 40% to about 60% methane is a stable gas turbine fuel, the adiabatic flame temperature of that mixture may be used herein as the standard for establishing a stable fuel mixture.

Techniques described herein also provide for the generation of power with low emissions using low value fuels, such as low BTU natural gas. In various embodiments, low cost CO₂ is generated and is used for EOR, as well as for the production of power from low value fuels. More specifically, a low pressure CO₂ circulation loop may be used to combust low value fuels with oxygen that has been mixed with CO₂ to make a synthetic air. The oxygen concentration may be varied to control the temperature of the combustion products. In addition, the heat from the combustion may be used to supply heat to a gas turbine, e.g., a combined cycle power plant. The combusted stream will be substantially CO₂ and water vapor, making it easy to inject downhole, or to use for EOR.

In addition, techniques described herein provide for the selective removal of H₂S from low BTU natural gas and the generation of hydrogen from the H₂S. The generated hydrogen may be used to increase the combustibility of other low-BTU fuels, e.g., vaporized gas from a bottoms liquid from a cryogenic distillation process, such as the CFZ process, or a bulk fractionation process. This provides a means of recovering the calorific value of the heavy hydrocarbons in the high-CO₂ liquid bottoms stream. For example, H₂S may be selectively removed from the low-BTU natural gas prior to the CO₂ removal process, e.g., the CFZ process. Hydrogen derived from the H₂S could then be used to increase the calorific value of the CFZ bottoms stream, which contains some level of heavy hydrocarbons.

Systems for Treating Low BTU Natural Gases for Use in Gas Turbines

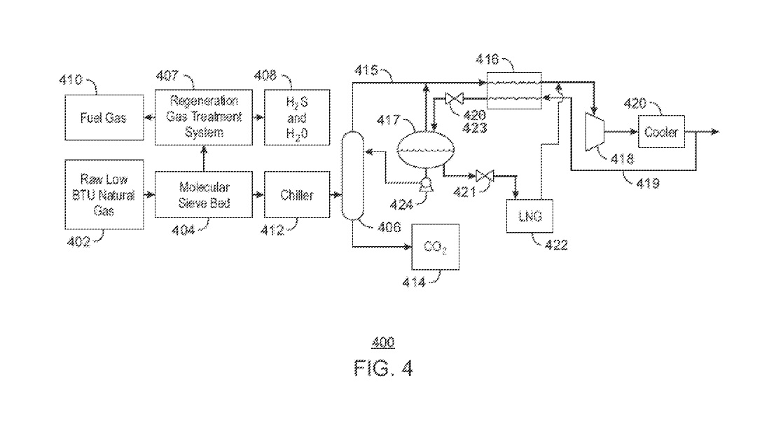

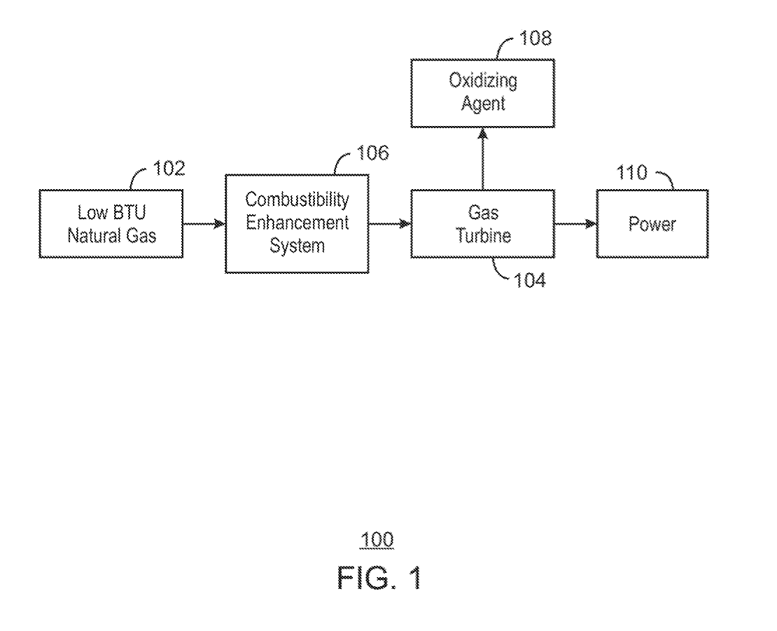

FIG. 1 is a block diagram of a system 100 for enhancing the combustibility of a low BTU natural gas 102. The low BTU natural gas 102 may be any type of natural gas with relatively low methane content by volume. For example, the low BTU natural gas 102 may include less than 40% methane content by volume. In many cases, stable gas turbine operation is not supported by natural gas with such low methane content. Thus, the system 100 may be used to increase the combustibility of the low BTU natural gas 102 such that the low BTU natural gas 102 is suitable fuel for a gas turbine 104.

In various embodiments, the combustibility of the low BTU natural gas 102 is increased within a combustibility enhancement system 106. Within the combustibility enhancement system 106, the combustibility of the low BTU natural gas 102 may be increased by increasing the adiabatic flame temperature of the low BTU natural gas 102. The adiabatic flame temperature of the low BTU natural gas 102 may be estimated by dividing the specific low heating value of the low BTU natural gas 102 by the product of the corresponding mass of the combusted stream and the average specific heat of the combustion products (from ambient to final temperature) at stoichiometric conditions.

Once the combustibility of the low BTU natural gas 102 has been increased, the low BTU natural gas 102 may be fed into the gas turbine 104. Further, in some embodiments, the combustibility of the low BTU natural gas 102 may be increased within the gas turbine 104 prior to the burning of the low BTU natural gas 102. Once the low BTU natural gas 102 is in a suitable state to be used as fuel for the gas turbine 104, an oxidizing agent 108, such as air, may be fed into the gas turbine 104. The low BTU natural gas 102 may then be burned, producing power 110.

The adiabatic flame temperature of the low BTU natural gas 102 may be increased by any of a number of different techniques. In various embodiments, the adiabatic flame temperature of the low BTU natural gas 102 is increased by spiking the low BTU natural gas 102 with heavy hydrocarbons, i.e., hydrocarbons with a carbon number of at least 2. Mixing heavy hydrocarbons with the low BTU natural gas 102 may increase the adiabatic flame temperature of the low BTU natural gas 102 because heavy hydrocarbons have higher adiabatic flame temperatures than methane. For example, if the low BTU natural gas 102 includes about 30% methane, spiking the low BTU natural gas 102 with propane is about twice as effective as adding additional methane to the low BTU natural gas 102.

The adiabatic flame temperature of the low BTU natural gas 102 may also be increased by increasing the temperature of the low BTU natural gas 102. Because the mass flow that provides the appropriate low heating value for the fuel within the gas turbine 104 is relatively high, raising the temperature of the low BTU natural gas 102, or of the mixture of the low BTU natural gas 102 and the oxidizing agent 108, prior to combustion can significantly increase the final flame temperature. The temperature of the low BTU natural gas 102 may be increased using, for example, a fuel heater.

The adiabatic flame temperature of the low BTU natural gas 102 may be increased by increasing the oxygen concentration of the mixture of the low BTU natural gas 102 and the oxidizing agent 108. For example, the adiabatic flame temperature of pure propane is over 1,000° F. higher when it is burned with pure oxygen instead of air. In some embodiments, an enriched oxygen stream is mixed with the mixture of the low BTU natural gas 102 and the oxidizing agent 108 within the gas turbine 104 using a nozzle.

The adiabatic flame temperature of the low BTU natural gas 102 may be increased by reducing the amount of moisture within the mixture of the low BTU natural gas 102 and the oxidizing agent 108. Moisture in the mixture may increase the mass of the combustion products, reducing the adiabatic flame temperature. Such moisture may be removed from the mixture using, for example, an inlet chiller.

Hydrocarbons may be burned in a reducing atmosphere, e.g., in sub-stoichiometric conditions, to produce a mixture of hydrogen, carbon monoxide, and carbon dioxide. Then, the adiabatic flame temperature of the low BTU natural gas 102 may be increased by spiking the low BTU natural gas 102 with this mixture, or with some portion of this mixture. For example, because hydrogen has a wide range of flammability, spiking the low BTU natural gas 102 with hydrogen may increase the combustion stability of the low BTU natural gas 102. Further, the adiabatic flame temperature of the low BTU natural gas 102 may be increased by passing the low BTU natural gas 102 over a catalyst, resulting in the generation of hydrogen from a portion of the methane, or other hydrocarbons, within the low BTU natural gas 102. This hydrogen may then be separated from the mixture and spiked into a second low BTU natural gas. In some embodiments, carbon monoxide is used instead of, or in combination with, the hydrogen.

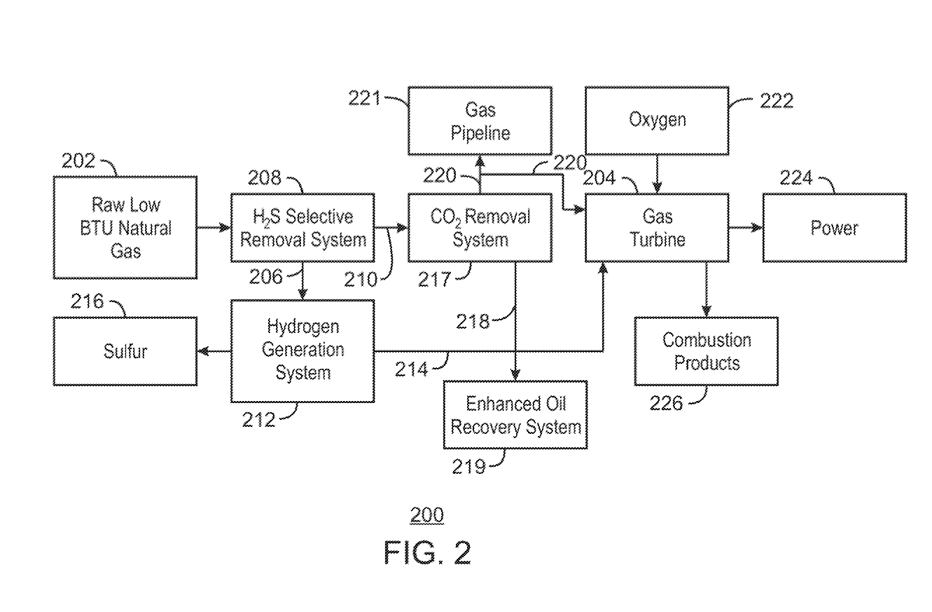

The techniques described above may be used individually or in any combination to increase the combustibility of the low BTU natural gas 102, depending on the desired combustibility of the low BTU natural gas 102 and the details of the specific implementation of the system 100. Such techniques, as well as additional techniques that may be used to increase the combustibility of the low BTU natural gas 102, are discussed further below with respect to FIGS. 2-6.

The block diagram of FIG. 1 is not intended to indicate that the system 100 is to include all of the components shown in FIG. 1. Further, the system 100 may include any number of additional components not shown in FIG. 1, depending on the details of the specific implementation.

FIG. 2 is a simplified process flow diagram of a system 200 for treating a raw low BTU natural gas 202 for use in a gas turbine 204 via the removal of hydrogen sulfide (H₂S) and carbon dioxide (CO₂). In various embodiments, the raw low BTU natural gas 202 includes less than 40% methane content by volume. Thus, the system 200 may be used to increase the combustibility of the raw low BTU natural gas 202 such that it is suitable fuel for the gas turbine 204.

The raw low BTU natural gas 202 may include hydrogen sulfide (H₂S), as well as relatively large amounts of carbon dioxide (CO₂). It may be desirable to selectively remove H₂S 206 from the raw low BTU natural gas 202 prior to a CO₂ removal process to obtain partially purified low BTU natural gas 210. Accordingly, within the system 200, the raw low BTU natural gas 202 may be fed into a H₂S selective removal system 208. The H₂S selective removal system 208 may separate the H₂S 206 from the raw low BTU natural gas 202 via any number of different processes. For example, a physical solvent process may be used to remove the H₂S 206 from the raw low BTU natural gas 202. According to the physical solvent process, a physical solvent such as Selexol®, which is a collection of di-methyl ethers of polyethylene glycol, may be used to selectively remove the H₂S 206 from the raw low BTU natural gas 202 in the presence of very little water.

An adsorptive kinetic separation (AKS) process may also be used to remove the H₂S 206 from the raw low BTU natural gas 202. The AKS process may utilize an adsorbent that relies on the rate at which certain species are adsorbed relative to other species, rather than on the equilibrium relative amounts of contaminants adsorbed. Such an adsorbent, or a combination of such adsorbents, may be used for the removal of the H₂S 206 and/or water. In addition, the AKS process may be used for CO₂ removal, CO₂-trim, and/or hydrogen purification at the end of the hydrogen generation cycle. Further, a selective amine process, redox process, adsorbent process, molecular sieve process, or the like, may be used to selectively remove the H₂S 206 from the raw low BTU natural gas 202.

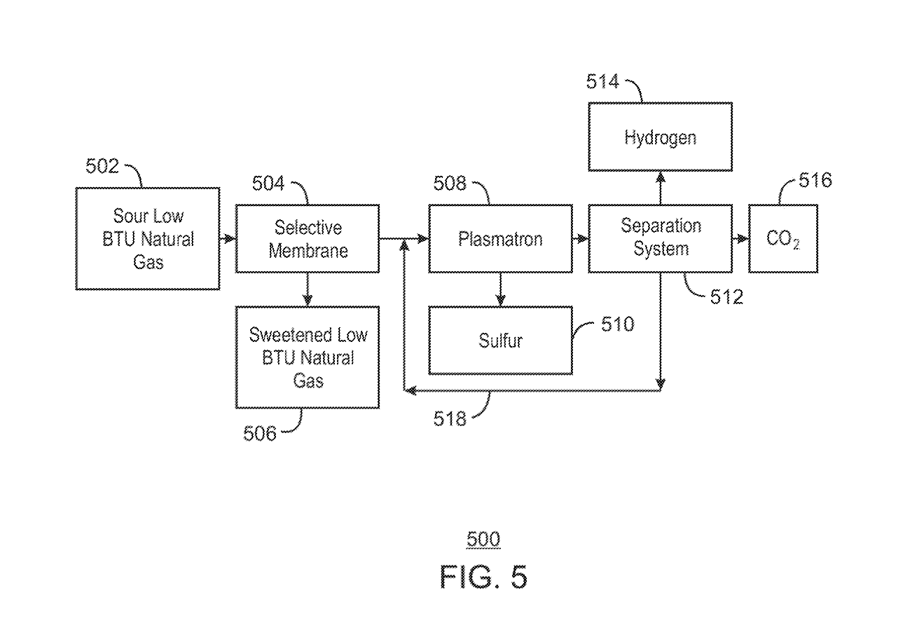

The H₂S 206 may be fed into a hydrogen generation system 212. The hydrogen generation system 212 may generate hydrogen 214 and sulfur 216 from the H₂S 206 via any of a number of different techniques, such as the plasmatron system discussed with respect to FIG. 5. The sulfur 216 may then be sent out of the system 200. In addition, the hydrogen 214 may be fed into the gas turbine 204, as discussed further below.

The partially purified low BTU natural gas 210 may be flowed from the H₂S selective removal system 208 to a CO₂ removal system 217. The CO₂ removal system 217 may remove CO₂ 218 and heavy hydrocarbons from the partially purified low BTU natural gas 210, producing a clean natural gas 220. In various embodiments, the CO₂ removal system 217 is a CFZ system. However, the CO₂ removal system 217 may also be any other type of removal system that is capable of separating heavy hydrocarbons along with CO₂ 218. In some embodiments, the CO₂ 218 is sent to an enhanced oil recovery (EOR) facility 219.

Some portion of the clean natural gas 220 may be sent out of the system 200 via a gas pipeline 221. In addition, the CO₂, heavy hydrocarbons, and a remaining portion of the clean natural gas 220 may be flowed into the gas turbine 204. In addition, the hydrogen 214 may be fed into the gas turbine 204. The mixing of the hydrogen 214 with the clean natural gas 220 may increase the combustibility of a separate stream of low BTU natural gas.

Oxygen 222, or any other suitable type of oxidizing agent, may be injected into the gas turbine 204. The mixture of oxygen 222, CO₂, heavy hydrocarbons, and the clean natural gas 220 is burned within the gas turbine 204, producing power 224. In addition, combustion products 226 produced within the gas turbine 204 may be sent out of the system 200. A portion of the combustion products 226 may be recycled, depending on the BTU value of the fuel. The combustion products 226 may include CO₂, which may be exported via a gas pipeline. In addition, the combustion products 226 may include particles, water vapor, carbon monoxide, nitrogen dioxide, or the like.

The power 224 that is generated by the gas turbine 204 may be provided to any of a number of different components of the system 200. For example, if the CO₂ removal system 217 is a CFZ system, some amount of the power 224 may be used to drive the refrigeration unit for the CFZ system. In addition, some amount of the power 224 may be used to drive the H₂S selective removal system 208 or the hydrogen generation system 212, or both.

The process flow diagram of FIG. 2 is not intended to indicate that the system 200 is to include all of the components shown in FIG. 2. Further, the system 200 may include any number of additional components not shown in FIG. 2, depending on the details of the specific implementation. For example, in some embodiments, the H₂S selective removal system 208 and the CO₂ removal system 217 are included within one system, such as, for example, a CFZ system.

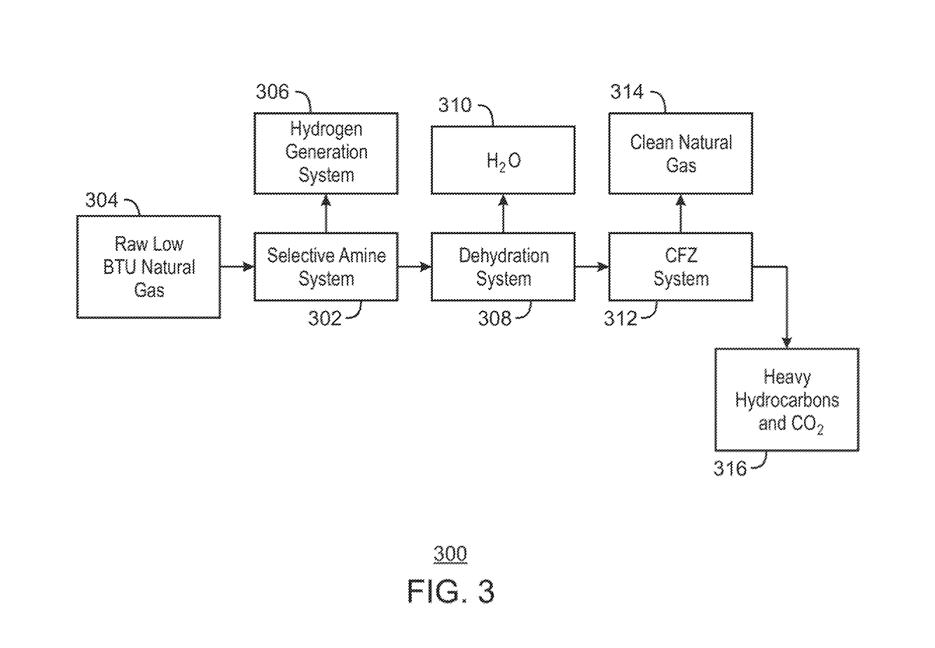

FIG. 3 is a simplified process flow diagram of a system 300 for removing H₂S and CO₂ from a low BTU natural gas via a selective amine process and a CFZ process. The selective amine system 302 uses amines, such as methyldiethanolamine (MDEA), to remove H₂S from CO₂-containing natural gas. Such amines have a relatively fast rate of H₂S adsorption compared to CO₂ absorption. Thus, the acid gases generated from selective amine system 302 are concentrated with respect to H₂S.

In various embodiments, the selective amine system 302 is used to remove H₂S from a raw low BTU natural gas 304. The H₂S removed may also contain some amount of the CO₂ that was in the raw low BTU natural gas 304. The resulting mixture may be fed into a hydrogen generation system 306.

In some embodiments, the selective amine system 302 includes compact contactors for the gas-liquid contacting device. Such devices can improve the selectivity of the amine by reducing the contact time, thus reducing the absorption of CO₂.

After the low BTU natural gas 304 exits the selective amine system 302, it may be water saturated. Thus, the low BTU natural gas 304 may be fed into a dehydration system 308. The dehydration system 308 may remove water 310 from the low BTU natural gas 304 in preparation for the CFZ process.

The dehydrated low BTU natural gas 304 may be fed into a CFZ system 312. The CFZ system 312 can produce a clean natural gas 314 by removing heavy hydrocarbons and CO₂ 316 from the low BTU natural gas 304. In various embodiments, the CFZ system 312 includes a CFZ column, or tower, that is essentially a refluxed demethanizer with a spray zone in the middle to handle frozen CO₂. A melt tray may be located underneath the spray zone. Within the melt tray, the solid CO₂ may be converted to a CO₂-rich liquid. The dry low BTU natural gas may be pre-chilled, typically from −35 to −60° F. In some cases, the chilled low BTU natural gas may also be expanded through a valve or turboexpander.

Once the H₂S, CO₂, and heavy hydrocarbons have been removed from the raw low BTU natural gas 304, the clean natural gas 314 may be sent out of the system 300 via a gas pipeline. In some embodiments, the clean natural gas 314 is burned within a gas turbine (not shown). In addition, heavy hydrocarbons or hydrogen from the hydrogen generation system 306, or both, may be used to increase the combustibility of the clean natural gas 314 prior to the burning of the clean natural gas 314 within the gas turbine.

The process flow diagram of FIG. 3 is not intended to indicate that the system 300 is to include all of the components shown in FIG. 3. Further, the system 300 may include any number of additional components not shown in FIG. 3, depending on the details of the specific implementation.

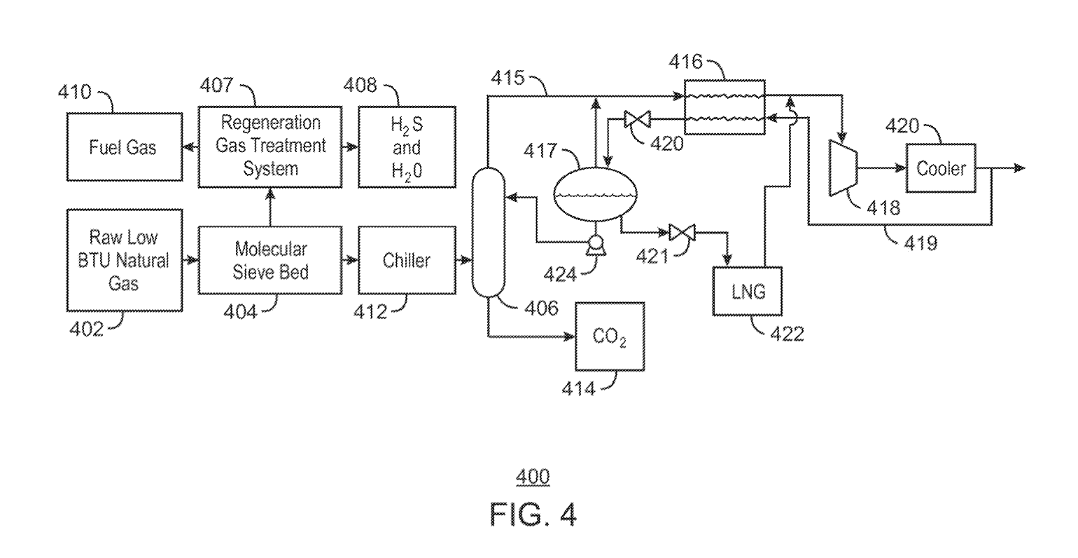

FIG. 4 is a simplified process flow diagram of a system 400 for removing H₂S and CO₂ from a raw low BTU natural gas 402 through the use of a molecular sieve bed 404 and a CFZ tower 406. Molecular sieves are solid adsorbents often used for dehydration. However, molecular sieves may also be used for H₂S and mercaptan removal. In many cases, molecular sieves are combined in a single packed bed, i.e., the molecular sieve bed 404. The molecular sieve bed 404 may also include a number of different types of molecular sieves. For example, a layer of 4 A molecular sieves, which have a pore size of around 4 Angstroms, may be positioned on the top of the molecular sieve bed 404 for dehydration of the low BTU natural gas 404, while a layer of 13× molecular sieves, which have a pore size of around 10 Angstroms, may be positioned on the bottom of the molecular sieve bed 404 for H₂S and mercaptan removal. Thus, the low BTU natural gas 402 may be both dried and de-sulfurized via a single molecular sieve bed 404.

Some amount of the capacity of the molecular sieves can be regenerated by a thermal swing or a pressure swing, or both. In addition, the spent regeneration gas generated within the molecular sieve bed 404 may be treated or disposed of. The regeneration gas may include natural gas, water, H₂S, and CO₂. In various embodiments, the regeneration gas from the molecular sieve bed 404 is fed into a regeneration gas treatment system 407, which may separate H₂S and H₂O 408 from fuel gas 410. The fuel gas 410 may be sent out of the system 400 via a pipeline (not shown), and the H₂S and H₂O 408 may be sent to a hydrogen generation system (not shown).

The treated natural gas 415 may be flowed out of the top of the CFZ tower 406. The temperature of the treated natural gas 415 may be increased within heat exchanger 416 to further chill stream 419. The pressure of the treated natural gas 415 may be increased within a compressor 418, and the temperature of the treated natural gas 415 may be further reduced within a cooler 420. The chilled, clean natural gas 419 may then be sent to heat exchanger 416 for further chilling prior to expansion through valve 420. The stream partially liquefies, and is captured in reflux drum 417. Part of the reflux may be introduced into CFZ tower 406 as a recycle stream via pump 424. Excess liquid reflux may exit system 400 as liquefied natural gas (LNG) after flashing through valve 421. Flash gases from the reflux drum 417, and from the LNG tank 422 can be recycled to compressor 418.

The treated natural gas 415 may be flowed out of the top of the CFZ tower 406. The temperature of the treated natural gas 415 may be further reduced within a heat exchanger 416 and a flash drum 417. The pressure of the treated natural gas 415 may be increased within a compressor 418, and the temperature of the treated natural gas 415 may be further reduced within a cooler 420. The chilled, clean natural gas may then be sent out of the system 400 as liquefied natural gas (LNG) 422. In addition, some portion of the LNG 422 may be used as the coolant within the heat exchanger 416. After passing through the heat exchanger 416, the LNG 422 may be flowed back into the CFZ tower 406 as a recycle stream. In some embodiments, the flow of the LNG 422 into the CFZ tower 406 is controlled via a control valve 424.

The process flow diagram of FIG. 4 is not intended to indicate that the system 400 is to include all of the components shown in FIG. 4. Further, the system 400 may include any number of additional components not shown in FIG. 4, depending on the details of the specific implementation.

FIG. 5 is a simplified process flow diagram of a system 500 for removing H₂S from a sour low BTU natural gas 502. In various embodiments, the sour low BTU natural gas 502 contains a significant amount of H₂S. For example, the sour low BTU natural gas 502 may include around 2-10% H₂S, as well as around 20%-75% CO₂ and greater than around 2% heavy hydrocarbons. The sour low BTU natural gas 502 may be flowed through a selective membrane 504 that is capable of separating the H₂S from the sour low BTU natural gas 502, producing a sweetened low BTU natural gas 506. In some embodiments, the selective membrane 504 may also be partially permeable to CO₂. Thus, some portion of the CO₂ may escape with the H₂S, while the remaining portion of the CO₂ may remain with the sweetened low BTU natural gas 506. Further, in some cases, the permeate side of the selective membrane 504 may be operated at sub-ambient pressure, e.g., under a vacuum, to improve the productivity of the selective membrane 504.

The sweetened low BTU natural gas 506 that is produced via the selective membrane 504 may be sent out of the system 500 via a pipeline. In various embodiments, some portion of the sweetened low BTU natural gas 506 is further treated or enhanced for burning within a gas turbine. For example, the sweetened low BTU natural gas 506 may be sent to a CO₂ removal system or a combustibility enhancement system.

The separated H₂S, as well as the residual CO₂, may be fed into a plasmatron 508. The plasmatron 508 may produce hydrogen and sulfur 510 from the H₂S. Within the plasmatron 508, an electrical discharge may generate a plasma, effectively energizing the electrons of the H₂S to make it more amenable to dissociation. This may be performed at pressures of up to around 0.3 atmospheres. The sulfur 510 that is generated within the plasmatron 508 may be sent out of the system 500.

In various embodiments, hydrogen, CO₂, and any residual H₂S may be flowed from the plasmatron 508 to a separation system 512. The separation system 512 may produce separated streams of hydrogen 514, CO₂ 516, and residual H₂S 518. In some embodiments, the hydrogen 514 may also include some amount of carbon monoxide. The CO₂ 516 may be sent out of the system 500 via a pipeline, for example, for reinjection or sale. The residual H₂S 518 may be recycled to the plasmatron 508 for further separation. In addition, some amount of the hydrogen 514 may be used to enhance the combustibility of the sweetened low BTU natural gas 506.

The process flow diagram of FIG. 5 is not intended to indicate that the system 500 is to include all of the components shown in FIG. 5. Further, the system 500 may include any number of additional components not shown in FIG. 5, depending on the details of the specific implementation. For example, the selective membrane 504 can be replaced with a pressure swing adsorption (PSA) bed. The PSA bed may include a solid sorbent that selectively adsorbs the H₂S within the sour low BTU natural gas 502. In addition, the solid sorbent may be regenerated by dropping the pressure of the PSA bed to low values. Further, the plasmatron 508 can be replaced by a thermolysis system or an electrolysis system. The thermolysis system may cause the dissociation of the hydrogen and the sulfur 510 within the H₂S as a result of the application of heat to the H₂S, while the electrolysis system may cause the dissociation of the hydrogen and the sulfur 510 within the H₂S as a result of the application of a direct electrical current to an aqueous solution of the H₂S.

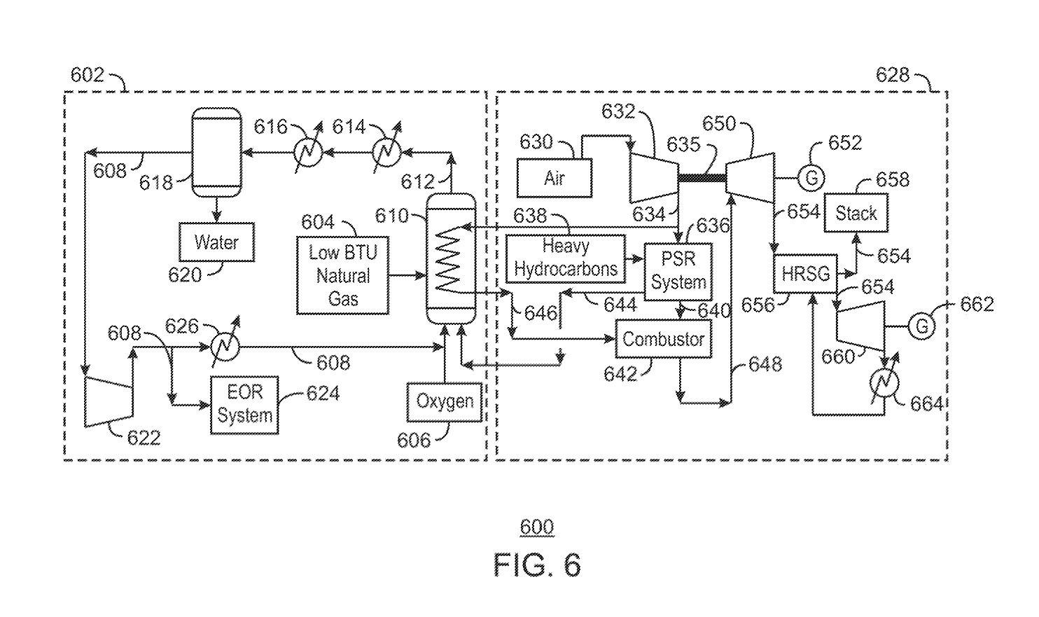

FIG. 6 is a simplified process flow diagram of a system 600 for generating CO₂ and producing power using low value fuels. The system 600 may include a CO₂ circulation loop 602 that combusts low BTU natural gas 604, or any other suitable type of fuel, with oxygen 606 that is mixed with CO₂ 608. Such a combustion process may be performed within a burn chamber 610. The concentration of the oxygen 606 within the burn chamber 610 may be varied to control the temperature of the combustion products 612, which may include CO₂ and H₂O, among others.

After exiting the burn chamber 610, the combustion products 612 may be flowed through the CO₂ circulation loop 602 in preparation for being reused within the burn chamber 610. In various embodiments, the combustion products 612 are cooled as they flow through the CO₂ circulation loop 602. For example, the combustion products 612 may be flowed through a first heat exchanger 614, which may include air cooling fins, and a second heat exchanger 616, which may include cooling water.

After the combustion products 612 have been cooled within the first heat exchanger 614 and the second heat exchanger 616, the combustion products 612 may be flowed through a flash drum 618. The flash drum 618 can perform a vapor-liquid separation process, generating water 620 and CO₂ 608. The water 620 may then be flowed out of the system 600.

In various embodiments, the CO₂ 608 is flowed through a compressor 622. The compressor 622 may increase the pressure of the CO₂ 608. Some portion of the CO₂ 608 may then be sent to an EOR system 624, or any other suitable system for disposal. The remaining portion of the CO₂ 608 may be flowed through a third heat exchanger 626, which may preheat the CO₂ 608. The heat energy for the third heat exchanger 626 may be provided from the first heat exchanger 614, for example, by combining these heat exchangers into a single heat exchanger. From the third heat exchanger 626, the CO₂ 608 may be mixed with the oxygen 606, and fed back into the burn chamber 610.

The system 600 may also include a power generation system 628. In various embodiments, air 630 is the working fluid for the power generation system 628. The air 630 may be flowed into a compressor 632, which may increase the pressure of the air 630, producing high-pressure air 634. The high-pressure air 634 may then be split between a pressure swing reforming (PSR) system 636 and the burn chamber 610.

The combustion of the mixture of the CO₂ 608 and the low BTU natural gas 604, heavy hydrocarbons 638 may be flowed into the PSR system 636 along with the high-pressure air 634. The PSR system 636 may generate hydrogen 640 and feed the hydrogen 640 into a combustor 642. In some embodiments, the combustor 642 is a diffusion type combustor. In addition, some amount of CO₂ 644 may be generated by the PSR system 636. Such CO₂ 644 may be fed into the burn chamber 610 along with the CO₂ 608.

In various embodiments, the combustion of the CO₂ 608 and the low BTU natural gas 604 within the burn chamber 610 increases the temperature of the high-pressure air 634, producing high-temperature air 646. The high-temperature air 646 may be fed into the combustor 642. Within the combustor 642, the hydrogen 640 and high-temperature air 646 are combusted, forming high-pressure combustion products 648, such as water vapor, carbon monoxide, nitrogen dioxide, and the like. The high-pressure combustion products 648 may be flowed through an expander 650. The flow of the high-pressure combustion products 648 through the expander 650 rotates the shaft 635, which connects the expander 650 to the compressor 632. Thus, the mechanical energy from the expander 650 may be used to power the compressor 632, completing the Brayton cycle. The rotation of the shaft 635 may result in the production of mechanical power, which may be used to produce electrical power in a generator 652.

Exhaust 654 from the expander 650 may be flowed into a heat recovery steam generator 656. The heat recovery steam generator 656 may recover heat from the exhaust 654. Some portion of the exhaust 654 may be vented to the atmosphere via a stack 658. The remaining portion of the exhaust 654 may be fed into an expander 660, which may produce mechanical power. Such mechanical power may then be converted to electrical power in a generator 662. In some embodiments, the exhaust is also fed through a heat exchanger 664 prior to being fed back into the heat recovery steam generator 656.

The process flow diagram of FIG. 6 is not intended to indicate that the system 600 is to include all of the components shown in FIG. 6. Further, the system 600 may include any number of additional components not shown in FIG. 6, depending on the details of the specific implementation. For example, in some embodiments, the low BTU natural gas 604 is a low value high carbon dioxide feed that contains sulfur. In such embodiments, a limestone fluid bed may be used to capture the sulfur in the low value high carbon dioxide feed. Primary and secondary cyclones may be used to capture solids in the combustion products and return the solids to the limestone fluid bed. In addition, a tertiary clean-up step may be used to capture fly ash or other small particles in the gas. Such a tertiary clean-up step may be accomplished using, for example, bag filters, electrostatic precipitators, or scrubbers.

Methods for Treating Low BTU Natural Gases for Use in Gas Turbines

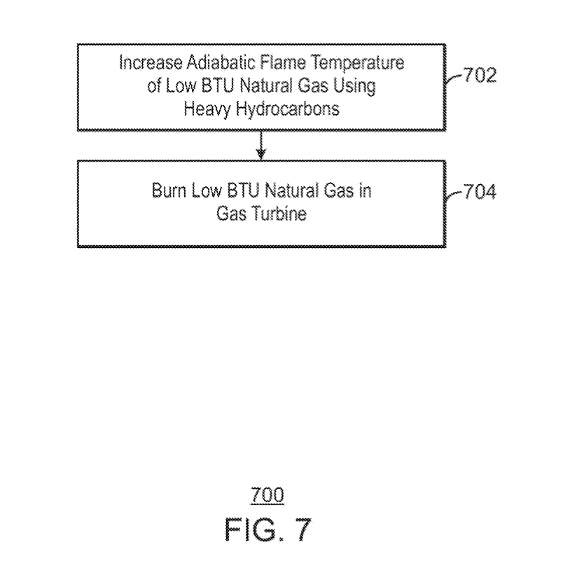

FIG. 7 is a process flow diagram of a method 700 for increasing the combustibility of a low BTU natural gas. The low BTU natural gas may include less than 40% methane content by volume. According to the method 700, the combustibility of the low BTU natural gas may be increased such that the low BTU natural gas is suitable to be used as fuel in a gas turbine.

The method 700 begins at block 702, at which the adiabatic flame temperature of the low BTU natural gas is increased using heavy hydrocarbons. The heavy hydrocarbons may be any suitable type of hydrocarbon with a carbon number of at least 2. In addition, the heavy hydrocarbons may include natural gas liquids (NGL).

In various embodiments, increasing the adiabatic flame temperature of the low BTU natural gas may result in a corresponding increase in the combustibility of the low BTU natural gas. The adiabatic flame temperature of the low BTU natural gas may be increased according to any of a number of different techniques. For example, the adiabatic flame temperature of the low BTU natural gas may be increased by spiking the low BTU natural gas with heavy hydrocarbons.

In some embodiments, heavy hydrocarbons are generated from a carbon dioxide removal process. This may include, for example, cryogenically separating carbon dioxide from the low BTU natural gas via a CFZ process. The heavy hydrocarbons may be fed into the gas turbine, and may increase the adiabatic flame temperature of the low BTU natural gas within the gas turbine.

Hydrogen may be generated from the heavy hydrocarbons via a pressure swing reforming process. The hydrogen may also be fed into the gas turbine, and may increase the adiabatic flame temperature of the low BTU natural gas within the gas turbine. Further, in other embodiments, the low BTU natural gas is spiked with hydrogen prior to entry into the gas turbine.

Hydrogen sulfide may be removed from the low BTU natural gas, and hydrogen may be generated from the hydrogen sulfide. The hydrogen sulfide may be removed from the low BTU natural gas using selective amines, physical solvents, molecular sieves, an adsorptive kinetic separation (AKS) process, or a hydrogen generation process, or any combinations thereof. In addition, the low BTU natural gas may be spiked with the hydrogen by feeding the hydrogen into the gas turbine. The hydrogen may be generated from the hydrogen sulfide via plasmolysis, thermolysis, or electrolysis, or any combinations thereof.

In various embodiments, the adiabatic flame temperature of the low BTU natural gas is increased by raising the temperature of a mixture of air and the low BTU natural gas within the gas turbine, increasing the concentration of oxygen within the mixture, or reducing the amount of moisture within the mixture. In addition, the adiabatic flame temperature of the low BTU natural gas may be increased by spiking the low BTU natural gas with a mixture containing hydrogen and/or carbon monoxide.

At block 704, the low BTU natural gas is burned in the gas turbine to produce power. The power that is generated may be used for any number of different applications. For example, some amount of the power may be used to increase the adiabatic flame temperature of additional low BTU natural gas, e.g., by compressing the feed gas.

In some embodiments, the gas turbine is included within a combined-cycle power plant including a heat recovery steam generator (HRSG) and a steam turbine. In such embodiments, hot exhaust from the gas turbine may be used to generate steam within the HRSG, and the steam may be used to drive the steam turbine.

The process flow diagram of FIG. 7 is not intended to indicate that the steps of the method 700 are to be executed in any particular order, or that all of the steps of the method 700 are to be included in every case. Further, any number of additional steps not shown in FIG. 7 may be included within the method 700, depending on the details of the specific implementation.

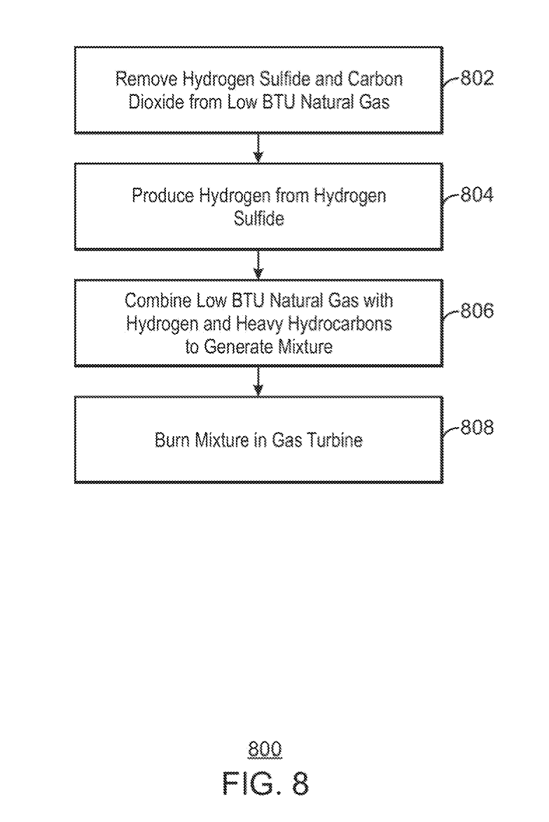

FIG. 8 is a process flow diagram of a method 800 for treating a low BTU natural gas for combustion in a gas turbine. The method begins at block 802, at which hydrogen sulfide and carbon dioxide are removed from the low BTU natural gas. The hydrogen sulfide may be removed from the low BTU natural gas via any of a number of techniques. For example, the hydrogen sulfide may be removed using selective amines, physical solvents, or molecular sieves. In addition, the hydrogen sulfide may be removed via an adsorptive kinetic separation (AKS) process or a hydrogen generation process, among others.

The carbon dioxide may be cryogenically separated from the low BTU natural gas via a CFZ process. In some embodiments, both the hydrogen sulfide and the carbon dioxide are cryogenically separated from the low BTU natural gas via the CFZ process.

At block 804, hydrogen is produced from the hydrogen sulfide. The hydrogen may be produced from the hydrogen sulfide via any of a number of different techniques. In some embodiments, the hydrogen is produced during the removal of the hydrogen sulfide from the low BTU natural gas at block 802.

At block 806, the low BTU natural gas is combined with the hydrogen, the heavy hydrocarbons, or both, to generate a mixture with a combustibility that is higher than the initial combustibility of the low BTU natural gas. In some embodiments, the temperature or oxygen concentration of the mixture may be increased, or the moisture of the mixture may be reduced, to increase the combustibility of the low BTU natural gas.

At block 808, the mixture is burned in the gas turbine to produce power. In some embodiments, some portion of the produced power is used to drive the method 800 for treating additional low BTU natural gas.

The process flow diagram of FIG. 8 is not intended to indicate that the steps of the method 800 are to be executed in any particular order, or that all of the steps of the method 800 are to be included in every case. Further, any number of additional steps not shown in FIG. 8 may be included within the method 800, depending on the details of the specific implementation.

### Embodiments

Embodiments of the invention may include any combinations of the methods and systems shown in the following numbered paragraphs. This is not to be considered a complete listing of all possible embodiments, as any number of variations can be envisioned from the description above.

1. A method for increasing a combustibility of a low BTU natural gas, including:

increasing an adiabatic flame temperature of the low BTU natural gas using heavy hydrocarbons, wherein the heavy hydrocarbons include compounds with a carbon number of at least two; and

burning the low BTU natural gas in a gas turbine.

2. The method of paragraph 1, including increasing the adiabatic flame temperature of the low BTU natural gas by spiking the low BTU natural gas with the heavy hydrocarbons.
3. The method of any of paragraphs 1 or 2, including:

recovering a portion of the heavy hydrocarbons from a carbon dioxide removal process; and

feeding the heavy hydrocarbons into the gas turbine, wherein the heavy hydrocarbons increase the adiabatic flame temperature of the low BTU natural gas within the gas turbine.

4. The method of paragraph 3, wherein recovering the portion of the heavy hydrocarbons from the carbon dioxide removal process (e.g., a controlled freeze zone (CFZ) process) includes cryogenically separating carbon dioxide from the heavy hydrocarbons.
5. The method of any of paragraphs 1-3, including:

generating hydrogen from the heavy hydrocarbons via a pressure swing reforming process; and

feeding the hydrogen into the gas turbine, wherein the hydrogen increases the adiabatic flame temperature of the low BTU natural gas within the gas turbine.

6. The method of any of paragraphs 1-3 or 5, including increasing the adiabatic flame temperature of the low BTU natural gas by spiking the low BTU natural gas with hydrogen.
7. The method of any of paragraphs 1-3, 5, or 6, including:

removing hydrogen sulfide from the low BTU natural gas;

generating hydrogen from the hydrogen sulfide; and

spiking the low BTU natural gas with the hydrogen by feeding the hydrogen into the gas turbine.

8. The method of paragraph 7, including generating the hydrogen from the hydrogen sulfide via plasmolysis.
9. The method of paragraph 7, including generating the hydrogen from the hydrogen sulfide via thermolysis or electrolysis, or any combination thereof
10. The method of paragraph 7, including removing the hydrogen sulfide from the low BTU natural gas using selective amines, physical solvents, molecular sieves, an adsorptive kinetic separation (AKS) process, or a hydrogen generation process, or any combinations thereof
11. The method of any of paragraphs 1-3 or 5-7, including increasing the adiabatic flame temperature of the low BTU natural gas by raising a temperature of a mixture of air and the low BTU natural gas within the gas turbine.
12. The method of any of paragraphs 1-3, 5-7, or 11, including increasing the adiabatic flame temperature of the low BTU natural gas by increasing a concentration of oxygen within a mixture of air and the low BTU natural gas within the gas turbine.
13. The method of any of paragraphs 1-3, 5-7, 11, or 12, including increasing the adiabatic flame temperature of the low BTU natural gas by reducing an amount of moisture within a mixture of air and the low BTU natural gas within the gas turbine.
14. The method of any of paragraphs 1-3, 5-7, or 11-13, including increasing the adiabatic flame temperature of the low BTU natural gas by spiking the low BTU natural gas with a mixture including hydrogen or carbon monoxide, or any combination thereof
15. The method of any of paragraphs 1-3, 5-7, or 11-14, including:

using hot exhaust from the gas turbine to generate steam within a heat recovery steam generator (HRSG); and

using the steam to drive a steam turbine, wherein the gas turbine and the steam turbine include a combined-cycle power plant.

16. The method of any of paragraphs 1-3, 5-7, or 11-15, wherein the heavy hydrocarbons include natural gas liquids.
17. The method of any of paragraphs 1-3, 5-7, or 11-16, wherein the low BTU natural gas includes less than forty percent methane content by volume.
18. A system for using a low BTU natural gas as fuel within a gas turbine, including:

a gas treatment system configured to increase a combustibility of the low BTU natural gas through the use of heavy hydrocarbons including a carbon number of at least two; and

a gas turbine configured to generate power using the low BTU natural gas, wherein a combustibility of the low BTU natural gas is increased.

19. The system of paragraph 18, wherein the heavy hydrocarbons are used to increase an adiabatic flame temperature of the low BTU natural gas.
20. The system of any of paragraphs 18 or 19, wherein the low BTU natural gas includes less than forty percent methane content by volume.
21. The system of any of paragraphs 18-20, wherein the heavy hydrocarbons include natural gas liquids.
22. The system of any of paragraphs 18-21, wherein the gas turbine is configured to allow hydrogen to flow into the gas turbine, and wherein the hydrogen increases the combustibility of the low BTU natural gas.
23. The system of any of paragraphs 18-22, including:

a hydrogen sulfide removal system configured to remove hydrogen sulfide from the low BTU natural gas: and

a hydrogen generation system configured to generate hydrogen from the hydrogen sulfide;

wherein the gas turbine is configured to allow the hydrogen to flow into the gas turbine, and wherein the hydrogen increases the combustibility of the low BTU natural gas.

24. The system of paragraph 23, wherein the hydrogen sulfide removal system includes selective amines, physical solvents, molecular sieves, or an adsorptive kinetic separation (AKS) system, or any combinations thereof.
25. The system of any of paragraphs 18-23, wherein the gas turbine is configured to increase a temperature of a mixture of air and the low BTU natural gas within the gas turbine in order to increase the combustibility of the low BTU natural gas.
26. The system of any of paragraphs 18-23 or 25, wherein the gas turbine is configured to accept an increased concentration of oxygen within a mixture of air and the low BTU natural gas within the gas turbine in order to increase the combustibility of the low BTU natural gas.
27. The system of any of paragraphs 18-23, 25, or 26, wherein the gas turbine is configured to decrease an amount of moisture within a mixture of air and the low BTU natural gas within the gas turbine in order to increase the combustibility of the low BTU natural gas.
28. The system of any of paragraphs 18-23 or 25-27, including a carbon dioxide removal system for separating carbon dioxide and the heavy hydrocarbons.
29. The system of paragraph 28, wherein the gas turbine is configured to allow the carbon dioxide and the heavy hydrocarbons to flow into the gas turbine in order to increase the combustibility of the low BTU natural gas.
30. The system of paragraph 28, wherein the carbon dioxide removal system includes a controlled freeze zone (CFZ) system.
31. The system of any of paragraphs 18-23 or 25-28, including a pressure swing reformer for generating hydrogen from the heavy hydrocarbons, wherein the gas turbine is configured to allow the hydrogen to flow into the gas turbine, and wherein the hydrogen increases the combustibility of the low BTU natural gas.
32. The system of any of paragraphs 18-23, 25-28, or 31, including:

a heat recovery steam generator (HRSG) for generating steam from hot exhaust from the gas turbine; and

a steam turbine configured to use the steam as fuel for the generation of power.

33. A method for treating a low BTU natural gas for combustion in a gas turbine, including:

removing hydrogen sulfide and carbon dioxide from the low BTU natural gas;

producing hydrogen from the hydrogen sulfide;

combining the low BTU natural gas with the hydrogen and heavy hydrocarbons to generate a mixture with a combustibility that is higher than an initial combustibility of the low BTU natural gas; and

burning the mixture in the gas turbine.

34. The method of paragraph 33, including removing the hydrogen sulfide from the low BTU natural gas using selective amines, physical solvents, molecular sieves, an adsorptive kinetic separation (AKS) process, or a hydrogen generation process, or any combinations thereof
35. The method of any of paragraphs 33 or 34, including cryogenically separating the carbon dioxide from the low BTU natural gas via a controlled freeze zone (CFZ) process.
36. The method of any of paragraphs 33-35, including:

using hot exhaust from the gas turbine to generate steam within a heat recovery steam generator (HRSG); and

using the steam to drive a steam turbine, wherein the gas turbine and the steam turbine include a combined-cycle power plant.

37. A method for treating a low BTU fuel for combustion in a gas turbine, including:

removing hydrogen sulfide from a low BTU natural gas;

producing hydrogen from the hydrogen sulfide;

generating a CO₂-rich heavy hydrocarbon bottoms stream from the sweetened low-BTU gas using a cryogenic process;

combining the CO₂-rich bottoms stream with the hydrogen to generate a mixture with a combustibility that is higher than an initial combustibility of the bottoms stream; and

burning the mixture in the gas turbine.

38. A method for generating a low BTU fuel for combustion in a gas turbine, comprising:

removing hydrogen sulfide from a low BTU natural gas;

generating a CO₂-rich, heavy hydrocarbon bottoms stream from the sweetened low-BTU gas using a cryogenic process;

combusting the CO₂-rich bottoms stream with oxygen to recover the calorific value of the associated heavy hydrocarbons; and

recovering the combusted stream for use in EOR.

While the present techniques may be susceptible to various modifications and alternative forms, the embodiments discussed above have been shown only by way of example. However, it should again be understood that the techniques are not intended to be limited to the particular embodiments disclosed herein. Indeed, the present techniques include all alternatives, modifications, and equivalents falling within the true spirit and scope of the appended claims.

What is claimed is:

1. A method for increasing a combustibility of a low BTU natural gas, comprising:
increasing an adiabatic flame temperature of the low BTU natural gas using heavy hydrocarbons, wherein the heavy hydrocarbons comprise compounds with a carbon number of at least two; and
burning the low BTU natural gas in a gas turbine.

2. The method of claim 1, comprising increasing the adiabatic flame temperature of the low BTU natural gas by spiking the low BTU natural gas with the heavy hydrocarbons.

3. The method of claim 1, comprising:
recovering a portion of the heavy hydrocarbons from a carbon dioxide removal process; and
feeding the heavy hydrocarbons into the gas turbine, wherein the heavy hydrocarbons increase the adiabatic flame temperature of the low BTU natural gas within the gas turbine.

4. The method of claim 3, wherein recovering the portion of the heavy hydrocarbons from the carbon dioxide removal process comprises cryogenically separating carbon dioxide from the low BTU natural gas via a controlled freeze zone (CFZ) process.

5. The method of claim 1, comprising:
generating hydrogen from the heavy hydrocarbons via a pressure swing reforming process; and
feeding the hydrogen into the gas turbine, wherein the hydrogen increases the adiabatic flame temperature of the low BTU natural gas within the gas turbine.

6. The method of claim 1, comprising increasing the adiabatic flame temperature of the low BTU natural gas by spiking the low BTU natural gas with hydrogen.

7. The method of claim 1, comprising:
removing hydrogen sulfide from the low BTU natural gas;
generating hydrogen from the hydrogen sulfide; and
spiking the low BTU natural gas with the hydrogen by feeding the hydrogen into the gas turbine.

8. The method of claim 7, comprising generating the hydrogen from the hydrogen sulfide via thermolysis or electrolysis, or any combination thereof.

9. The method of claim 7, comprising removing the hydrogen sulfide from the low BTU natural gas using selective amines, physical solvents, molecular sieves, an adsorptive kinetic separation (AKS) process, or a hydrogen generation process, or any combinations thereof.

10. The method of claim 1, comprising increasing the adiabatic flame temperature of the low BTU natural gas by at least one of:
(i) raising a temperature of a mixture of air and the low BTU natural gas within the gas turbine;
(ii) increasing a concentration of oxygen within a mixture of air and the low BTU natural gas within the gas turbine;
(iii) reducing an amount of moisture within a mixture of air and the low BTU natural gas within the gas turbine; and
(iv) spiking the low BTU natural gas with a mixture comprising hydrogen or carbon monoxide, or any combination thereof.

11. The method of claim 1, comprising:
using hot exhaust from the gas turbine to generate steam within a heat recovery steam generator (HRSG); and
using the steam to drive a steam turbine, wherein the gas turbine and the steam turbine comprise a combined-cycle power plant.

12. The method of claim 1, wherein the heavy hydrocarbons comprise natural gas liquids.

13. The method of claim 1, wherein the low BTU natural gas comprises less than forty percent methane content by volume.

14. A system for using a low BTU natural gas as fuel within a gas turbine, comprising:
a gas treatment system configured to increase a combustibility of the low BTU natural gas through the use of heavy hydrocarbons comprising a carbon number of at least two; and
a gas turbine configured to generate power using the low BTU natural gas, wherein a combustibility of the low BTU natural gas is increased.

15. The system of claim 14, wherein the heavy hydrocarbons are used to increase an adiabatic flame temperature of the low BTU natural gas.

16. The system of claim 14, wherein the heavy hydrocarbons comprise natural gas liquids.

17. The system of claim 14, wherein the gas turbine is configured to allow hydrogen to flow into the gas turbine, and wherein the hydrogen increases the combustibility of the low BTU natural gas.

18. The system of claim 14, comprising:
a hydrogen sulfide removal system configured to remove hydrogen sulfide from the low BTU natural gas: and
a hydrogen generation system configured to generate hydrogen from the hydrogen sulfide;
wherein the gas turbine is configured to allow the hydrogen to flow into the gas turbine, and wherein the hydrogen increases the combustibility of the low BTU natural gas.

19. The system of claim 18, wherein the hydrogen sulfide removal system comprises selective amines, physical solvents, molecular sieves, or an adsorptive kinetic separation (AKS) system, or any combinations thereof.

20. The system of claim 14, wherein the gas turbine is configured to increase a temperature of a mixture of air and the low BTU natural gas within the gas turbine in order to increase the combustibility of the low BTU natural gas.

21. The system of claim 14, wherein the gas turbine is configured to accept an increased concentration of oxygen within a mixture of air and the low BTU natural gas within the gas turbine in order to increase the combustibility of the low BTU natural gas.

22. The system of claim 14, wherein the gas turbine is configured to decrease an amount of moisture within a mixture of air and the low BTU natural gas within the gas turbine in order to increase the combustibility of the low BTU natural gas.

23. The system of claim 14, comprising a carbon dioxide removal system for generating carbon dioxide and the heavy hydrocarbons.

24. The system of claim 23, wherein the gas turbine is configured to allow the carbon dioxide and the heavy hydrocarbons to flow into the gas turbine in order to increase the combustibility of the low BTU natural gas.

25. A method for treating a low BTU natural gas for combustion in a gas turbine, comprising:
removing hydrogen sulfide and carbon dioxide from the low BTU natural gas;
producing hydrogen from the hydrogen sulfide;
combining the low BTU natural gas with the hydrogen and heavy hydrocarbons to generate a mixture with a combustibility that is higher than an initial combustibility of the low BTU natural gas; and
burning the mixture in the gas turbine.
